(19) United States
(12) Patent Application Publication
(10) Pub. No.: US 2015/0189096 A1
(43) Pub. Date: Jul. 2, 2015

(54) METHOD FOR OPTIMIZING TRAFFIC VOLUME CAPS IN WIRELESS CELLULAR NETWORKS

(71) Applicant: TELEFONICA DIGITAL ESPANA, S.L.U., Madrid (ES)

(72) Inventors: Rade STANOJEVIC, Madrid (ES); Vijay ERRAMILLI, Madrid (ES)

(73) Assignee: TELEFONICA DIGITAL ESPANA, S.L.U., Madrid (ES)

(21) Appl. No.: 14/141,799

(22) Filed: Dec. 27, 2013

(51) Int. Cl. H04M 15/00

(52) U.S. Cl. CPC H04M 15/60; H04M 15/785

(57) ABSTRACT

Method for optimizing traffic volume caps in mobile cellular networks comprising: defining three traffic volume caps (x, y, z), wherein x indicates number of messages from mobile messaging services, y indicates bandwidth for mobile data and z indicates duration time of voice calls; computing initial user balance by subtracting total traffic cost generated by user for the mobile cellular network operator from total revenue paid by user to the mobile cellular network operator; obtaining total user balance for a range of caps (x, y, z) using the initial balance and at least a, net-oblivious or net-aware balance model which determines whether user is affected by the caps (x, y, z); selecting optimal traffic volume caps which maximize the total user balance. The method also computes social attraction parameters pk as a fraction of customers of the mobile cellular network operator having k contacts in the mobile cellular network operator.

### FIELD OF THE INVENTION

The present invention has its application within the telecommunication sector and in particular applied to wireless communications systems. This invention relates to cellular networks pricing by optimizing traffic volume caps.

### BACKGROUND OF THE INVENTION

A volume cap, bandwidth cap, also known as a band cap, limits the transfer of a specified amount of data over a period of time. Internet service providers (ISPs) commonly apply a cap when a channel intended to be shared by many users becomes overloaded, or may be overloaded, by a few users. Mobile telcos have widely implemented volume cap based data pricing in order to regain control of their margins by curbing heavy broadband usage. There are several studies on the effect of volume caps in Usage-Based Pricing (UBP) by ISPs, for example, in “You're Capped! Understanding the Effects of Bandwidth Caps on Broadband Use in the Home.” Chetty et al., Proceedings of CHI 2012, ACM Conference on Human Factors in Computing Systems May 5-10, 2012.

Cellular networks around the world have a very diverse set of pricing plans. In general, pricing plans can be thought of as being on a spectrum, where on one end lies a single flat rate for ‘unlimited’ usage, and on the other end lies pure usage based pricing (UBP) where every unit of the service (voice minutes, messages of Short Message Service—SMS-, data) consumed is metered and charged. Most operators however offer plans that lie somewhere in the middle of the spectrum. The typical offerings are monthly plans with a specific flat rate charged for a bundle of services—specific volumes of voice/SMS/data.

As the network services industry (wired and wireless) has experienced high growth in virtually every corner of the world in the previous decades, pricing mechanisms have fueled, among other factors, this growth and can lead to profits for network operators as they are conducive to attract and engage users. The growth of the subscriber base is seen as one of the most important metrics to reflect success. Towards this end, pricing schemes tend to be simple; have a flat rate and contain an abundant amount of communication units (all-you-can-eat buffet plans) to attract a large user base.

On the other hand, many network operators offer social incentives to attract new customers. These incentives normally come in the form of unlimited volume of voice minutes or SMSs between users of the same network, and are incorporated in the pricing plan/tariffs.

In recent years, many network operators, especially those in mature markets, have seen their revenues and profits saturating or even decaying. One of the reasons of this trend lies on an unprofitable user behavior, where some users lead to more cost to the network than revenue, and are therefore being cross-subsidized by other users. Similarly, user's activity with other users in the network also plays an important role in the revenue/cost of the operator.

If considering the history of telecommunication services, there is a distinctive trend of charging ‘flat’ fees for services: telegraph, post, fixed and mobile telephony, residential broadband, etc. This practice is justified by the customers' preference for convenient and simple tariffs as well as very low cost for the provider for accounting and delivering the service. In addition, users are willing to pay extra money for the convenience of not worrying about high bills that can result due to usage based pricing (UBP). There has been a lot of work on pricing issues in the Internet, including discussing relative merits and demerits of UBP in access and cellular networks, but the general consensus is that UBP is used in access networks to raise revenues while it is used in cellular networks to cope with congestion and runaway growth. It has also been suggested that UBP can be used to put an end to cross-subsidization.

Current used methods to calculate volume caps either respond to network congestion constraints, or respond to some kind of proprietary undisclosed formulae which may take into account the market conditions, market segmentation or other factors.

Some prior state of the art has examined the validity of the volume caps through analysis of empirical data of fixed telephone services, for example, “Empirical consideration of the effects of bit/data cap on telecommunications operators” by Kazuma Kobayashi et al., The International Journal of Economic Policy Studies, Volume 7, Article 7, 2012. The purpose of this prior-art publication is to take empirical data as input to try to justify the choice of a data cap in a fixed telephone network by several service providers, as well as examining factors that determine this cap, including also policy issues into consideration. However, said prior-art does not address the optimization calculation problem of volume caps in based on user balance optimization (i.e., revenue minus network costs associated to each user). Additionally, the domain in this prior work is fixed telephone services, instead of wireless cellular networks.

Therefore, there is a need in the state of the art for setting volume caps or traffic limits for monthly flat rate plans to alleviate cross-subsidization and increase profits for cellular network operators.

### SUMMARY OF THE INVENTION

The present invention solves the aforementioned problems by disclosing a method and computer program that provides a quantitative optimization for the setting of the volume caps in a usage based pricing (UBP) cellular billing system. More particularly, the invention refers to a method for optimizing the setting of three parameters related to traffic volume caps, which can be used in a flat-rate mobile broadband tariff scheme, for example: messages from mobile messaging services such as SMS (Short Message Service), MMS (Multimedia Messaging System), IM (Instant Messaging), etc., bytes of mobile broadband and time of free on-net calls. Thus, the method allows the mobile network providers to maximize profits and remove unprofitable user behavior, taking as inputs, not only the individual value of a user in the network, but also the social effect of interactions with other users in the networks.

The present invention has its application in mobile networks independently of whether the mobile provider is a Mobile Network Operator (MNO) or a Mobile Virtual Network Operator (MVNO).

Evaluating the cost per user is out of scope of this invention. It is assumed that understanding the user behavior is a critical factor that drives not only the quarterly balance sheet, but also long-term strategy and network development, for targets low-income as for high-income segments of the market. Therefore, the relationship between the users' usage patterns on revenues and cost, studied holistically, is pivotal in determining how future networks will evolve. For the purpose of evaluating potential gains. In the context of the present invention, a linear cost model is used, in which each service unit (voice minute, SMS/MMS messages or Mbyte of mobile broadband) generates fixed cost to the cellular operator, which is common for virtual operators (MVNOs).

The present invention incorporates social user behavior by modeling the relationship between the number of contacts of a user that are customers of the network operator and the likelihood that this user is a customer of the operator. Such network effects and call graph interactions used as input for the traffic volume cap optimization problem have not been taken into account by any prior-art solution.

In the context of the invention, the user-behavior in a social network is defined by the call graph. A call graph is a directed graph that represents calling relationships between users. That is, the social graph is observed via voice calls and mobile messaging services (SMS, MMS, IM, etc.). This invention uses the call graph between customers of the operator to model their interactions.

According to an aspect of the present invention, a method of traffic volume caps optimization in cellular networks is disclosed and comprises the following steps:
defining three traffic volume caps (x, y, z), wherein a first volume cap x indicates number of messages from mobile messaging services (e.g., SMSs, MMSs, . . . ), a second volume cap y indicates bandwidth for mobile data and a third volume cap z indicates duration time of voice calls;
computing an initial balance of the user by subtracting a total traffic cost generated by the user for the mobile cellular network operator from a total revenue paid by the user to the mobile cellular network operator;
obtaining a total balance of the user for a range of traffic volume caps (x, y, z) using the initial balance and at least a model of the balance which determines whether the user is affected by the traffic volume caps (x, y, z);
selecting optimal traffic volume caps (xₒₚₜ, yₒₚₜ, zₒₚₜ) which maximize the total balance for the user.

In a possible embodiment of the invention, the model used for computing the total balance of the user is a net-oblivious model.

In another possible embodiment of the invention, social attraction parameters pₖ for k=0, 1, 2, . . . , are defined and computed by the method, wherein a social attraction parameter pₖ is a fraction of customers of the mobile cellular network operator which have k contacts in the mobile cellular network operator. A net-aware model which uses these social attraction parameters can be applied by the method, in a possible embodiment, to obtain the total balance of the user.

In another aspect of the present invention, a computer program is disclosed, comprising computer program code means adapted to perform the steps of the described method when said program is run on a computer, a digital signal processor, a field-programmable gate array, an application-specific integrated circuit, a micro-processor, a micro-controller, or any other form of programmable hardware. Also a digital data storage medium storing a computer program product is provided, comprising instructions causing a computer executing the program, to perform all steps of the method described before

The method in accordance with the above described aspects of the invention has a number of advantages with respect to prior art, summarized as follows:
The present invention provides a simple yet reliable method for volume cap determination for mobile network users.
The present invention allows the network operators to exert a network usage control for individual users.
The present invention, in addition to the individual user behavior, takes into account the user interactions in the call graph and incorporates the social user behavior in the framework for more accurately assessing the value of each user to the network.
The present invention alleviates cross-subsidization of network users in a flat rate broadband tariff without incurring in profit decrease.
The present invention removes unprofitable user behavior.

These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 presents a flow chart with the main steps of the method for optimizing volume caps in cellular networks, in accordance with a preferred embodiment of the invention.

FIG. 2 shows a graphical representation of social attraction parameters pₖ for a cellular network operator, according to a preferred embodiment of the invention in possible application scenario of the invention.

FIG. 3 shows a graphical representation of relative total balance, according to a preferred embodiment of the invention in a possible application scenario of the invention.

FIG. 4 shows a graphical representation of the fraction of nodes in a social network affected by volume caps, according to a preferred embodiment of the invention in a possible application scenario of the invention.

FIG. 5 shows a histogram of per-user balance in the case that volume caps are calculated according to a possible embodiment of the invention and the per-user balance without using volume caps.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

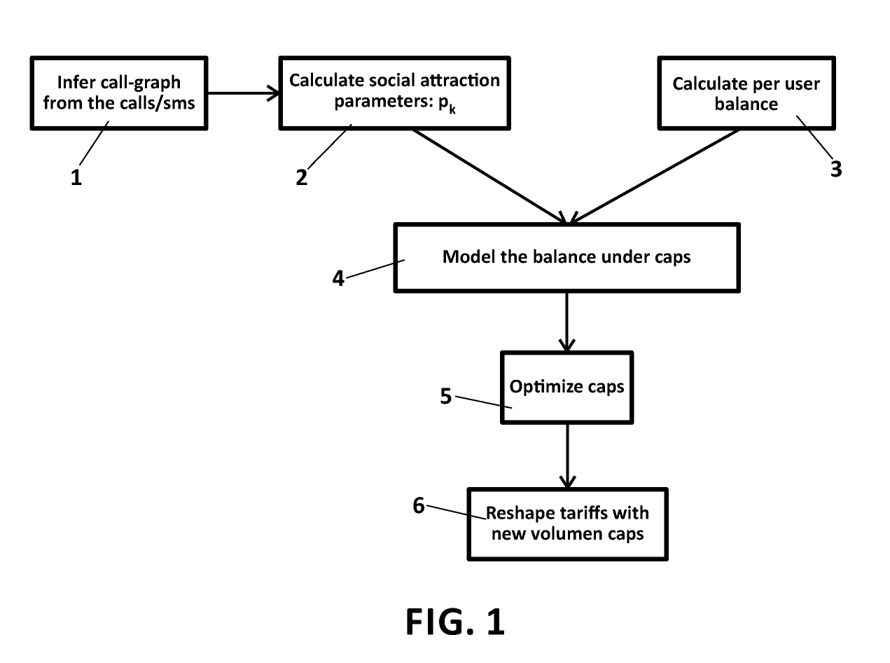

It is within this context, that various embodiments of the invention are now presented with reference to the FIGS. 1-5.

FIG. 1 presents the main steps of the proposed method for optimizing volume caps in cellular networks according to a preferred embodiment of the invention. Starting from the voice calls and SMSs referring to a given user, the call graph is inferred (1) firstly. Then, in order to calculate the optimal volume caps (5), two key metrics are defined/calculated, the social attraction parameters pₖ (2) and the per-user balance (3), and used as inputs to model a Balance under caps (4).

The proposed optimization method determines a metric on how much each user of the service contributes to the overall revenues and costs of the operator. For this purpose, the method uses both a metric on the payments made by the user and regarding the cost imposed by the user when using non-metered services in this operator.

On one hand, Balance is defined as the difference between the total revenue R(u) that a given user u paid to an operator for the network services and the total traffic cost C(u) that the user u generated for the operator. This balance is calculated (3) for each user u, this per-user balance being denoted by b(u) and defined by the expression:

b(u)=R(u)−C(u).

The revenue term R(u) is calculated on the basis of the analysis of the billing records for the user over a predefined time period.

Balance b(u) is derived from the estimation of net income from the user, obtained by subtracting the overall cost the user generated from the overall revenue that this user contributed to the operator. Calculating the revenues from the user is rather straightforward, but calculating the cost incurred by the user is not as straightforward. In case of mobile virtual network operators (MVNO) the cost is a linear function of the usage. In regular (non-virtual) mobile operators, the cost of running the cellular network is related to the demand via capacity planning. For example, the decision to build a base transceiver station (BTS) in a particular area depends on the estimated peak demand in that area, which means that users that contribute to the demand in the peak times are more ‘costly’ than the users which consume the network resources in the off-peak times. In addition not every BTS costs the same, and consequently estimating the cost that a particular customer puts on the network depends both on the time and the place that the user places her/his requests.

The balance measures how profitable the user is for the operator. Users u with large balance b(u) are very profitable for the operator, while users u with negative balance b(u) generate uncovered costs which must be subsidized by those with positive balance.

On the other hand, the social attraction parameters pₖ are defined to evaluate the effects of node removal on its contacts and the impact of such cascade removal process on the revenues and costs of the operator. Given voice calls and messages from mobile messaging services (e.g., SMS data), an operator can detect whether a user (on-net or off-net) is a contact with an existing customer of the operator. A mobile user v is the contact of a customer u only if there is at least one interaction (voice or mobile message) between the customer u and the user v in both directions. For k=0, 1, 2, . . . , Nₖ denotes the number of customers of the operator with exactly k contacts in the operator and Fₖ denotes the number of national mobile users (both on-net and off-net), with exactly k contacts in the operator. In this context, the term “national” refers to the current location of the customers and not to country of origin. Hence, N₀ denotes the number of existing customers of the operator who have 0 (zero) contacts within the operator. Likewise, F₀ denotes the number of all mobile users in the country who have 0 contacts in the operator. To understand the relationship between the number of contacts of the operator's customer u and the likelihood that this user u is customer of the operator, the following metric, here called social attraction parameter pₖ is defined as:

$${p}_{k} = \frac{{N}_{k}}{{F}_{k}} , k = 0 , 1 , 2 , …$$

Thus, pₖ is the fraction of users from the entire national mobile user base with k contacts in the operator and determines the impact of social ties in the growth of the network from a macroscopic point of view.

In case of mobile virtual network operator (MVNO), the cost of a user is calculated in straightforward manner by adding the cost of voice calls, SMS and 3G data generated by the user, charged at the wholesale rates of p_{M}/min, p_{S}/SMS and p_{D}/MB. For example a user which generated 600 minutes of voice calls, 300 SMSs, and 1.2 Gbyte of mobile data, incurres the cost of: 600*p_{M}+300*p_{S}+1200*p_{D}. In case of regular mobile network operators (MNO), calculation of the cost must take into account the location and the time when the user generates the load to the network.

Once the social attraction parameters pₖ and the per-user balance are calculated (2, 3), the module for optimizing the caps calculates the optimal caps (5) in an appropriate model which captures the effect of the caps on the overall balance. These optimal caps (5) can then be used by the mobile providers, MNOs or MVNOs, to re-establish new tariffs (6).

The mobile operator can compute the number of its customers Nₖ for any k≧0 and the number of national mobile users Fₖ for k≧1, from its data since the operator archives any voice or mobile messaging service interaction in which one (sending or receiving) party is a customer of the operator. However, computing F₀ is not as straightforward, since no information regarding the communications that happen outside the operator is available for said operator. In order to estimate F₀, the total number T₀ of mobile phone users in the country is estimated first as:

$${F}_{0} = {T}_{0} - {\sum }_{K \geq 1} {F}_{k}$$

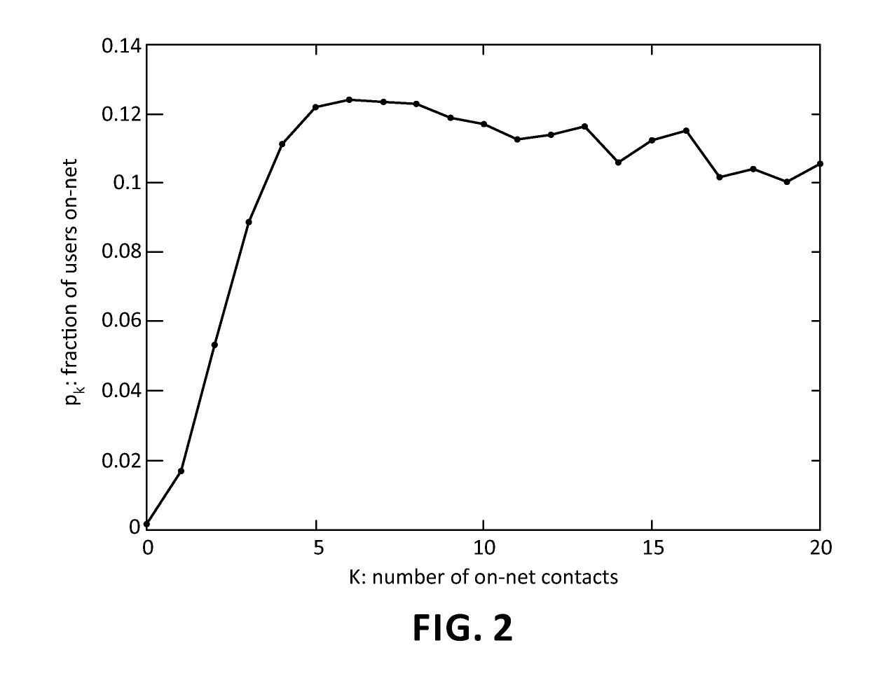

For example, FIG. 2 shows the social attraction parameters pₖ for a national cellular operator whose data is analyzed further below. FIG. 2 illustrates pₖ as the fraction of on-net users versus the number of contacts k in the operator, i.e., the number of contacts k versus the likelihood of being the customer of the operator, and the graphic shows, for example, that having more contacts in the operator increases chances of being a customer of the operator up to k=5.

In order to calculate the optimal caps (5), the proposed method uses a model of the balance under the use of caps (4). This model is one of two models used to determine the impact and quantify the effects of the caps on user behavior, and hence the revenues and costs. In the first model (Net-oblivious model), the users affected by the cap are only those that cross the cap. The second model (Net-aware model) is a more general model which also takes into account the social ties between the users to capture the social network effects that can arise due to the introduction of caps. Optimal volume caps are calculated (5) under the two models, with the goal of optimizing profits.

In the net-oblivious model, it is assumed that if a user consumes more service units than what the cap offers, the user either quits the network or the overage charges compensate for the extra traffic consumed by the user, thus bringing balance of the user to zero. More formally, if the user u consumes sᵤ SMSs, dᵤ MBytes of mobile broadband and fᵤ minutes of on-net calls, on average, and the operator packages have caps of x SMSs, y MBytes of mobile broadband and z minutes of free on-net calls, the user u is said to be affected by these caps only if the user u consumes more service than the cap quota in at least one of the three services: SMS, mobile data volume and call duration time. In the net-oblivious model, if a user u is affected by the cap, it is assumed that the user u is not a customer of the operator and, hence, has balance equal to zero; otherwise, neither usage nor charge of the user is affected by the caps and thus balance bᵤ under caps (x, y, z) defined by the operator remains the same, i.e.,:

$${b}_{u}^{( x , y , z )} = \{ \begin{matrix}0 & if ( {s}_{u} > x ) ⋁ ( {d}_{u} > y ) ⋁ ( {f}_{u} > z ) \\ b ( u ) & otherwise\end{matrix}$$

The users with large consumption of non-metered services are the ones that are cross-subsidized and putting a cap on how much of the free services they obtain in the package that they purchase should reduce the instances of cross-subsidization and increase the total balance B(x, y, z) defined as:

$$B ( x , y , z ) = {\sum }_{u} {b}_{u}^{( x , y , z )}$$

To find the optimal caps, the solution of the optimization problem is computed:

(xₒₚₜ, yₒₚₜ, zₒₚₜ)=arg max_{x≧0,y≧0,z≧0} B(x, y, z)

Thus, Balance B(x,y,z) is measured for a range of possible caps (x.y,z), and the cap which maximizes the total balance is selected. In this first model, it can be observed that the user affected by caps either does not change her/his behavior in terms of their usage and payments, in case that the user remains under the cap, or the user has zero balance if crossing the cap.

In the second model, the net-aware model, a social graph G=(V,E) is considered the with the set of nodes V being the customers of the operator and the edges E between the nodes representing whether the customers have interacted using the network infrastructure (via voice calls or SMS). In this social graph G, two sets of nodes are distinguished: set A contains the set of nodes affected by the cap, while those nodes that are not affected by the cap are in set Ac. The balance bᵤ under caps (x, y, z) of user u is either 0, if the user u is an affected node (u ∈ A), or is the same as the original balance, b(u), if the user u is not affected (u ∈ Ac):

$${b}_{u}^{′ ( x , y , z )} = \{ \begin{matrix}0 & if u is affected \\ b ( u ) & otherwise\end{matrix}$$

To decide which nodes are affected, the following recursive procedure is performed. Every node that uses more than x SMSs or more than y MBytes of mobile broadband or more than z minutes of free on-net calls is added to the set A of affected nodes. Each time a node u is added to set A, every contact v of the user u is added to the set A of affected nodes with a probability 1−pₖ₋₁/pₖ where k is the number of contacts of the node v among yet non-affected nodes (including the user u) and pₖ is the probability that a user (from a pool of all mobile users in the country) is the customer of the operator conditioned on the fact that the user has k contacts that are customers of the operator. The estimation of social attraction parameters pₖ, described before, provides basis for understanding the macroscopic behaviour model that captures the relationship between the social network of a user and the social pressure that makes this user become a customer of the operator. Note that the conditional probability that node v with k>0 contacts on-net remains the customer of the operator after one of the contacts leaves the operator is indeed pₖ₋₁/pₖ. Hence, the probability that the user gets affected is 1−pₖ₋₁/pₖ, as explained above.

Once the set A of affected nodes is computed, the total balance B′ is calculated as:

$${B}^{′} ( x , y , z ) = {\sum }_{u} {b}_{u}^{′ ( x , y , z )}$$

and the optimal caps (x, y, z) are those ones that maximize the total balance B′.

Empirically, the probabilistic nature of the procedure that determines the set A of affected nodes has very small influence on the total balance B′. Usually, the sample standard deviation of B′(x, y, z) is two orders of magnitude smaller than the sample mean and, hence, for the analysis of how caps affect the total balance, a single instance of the procedure can be used to calculate the total balance B′^{(x,y,z)}.

The pseudo-code of the above procedure for calculating the set A of affected nodes is shown below:

| Data: G = (V, E): Social graph | | |
|---|---|---|
| (x, y, z): caps | | |
| sᵤ, dᵤ, fᵤ: average per service usage of customer u ε V | | |
| pₖ: probability that a user with k contacts is customer of the | | |
| network | | |
| Result: Compute set A of affected nodes | | |
| begin | | |
| \| | A = ; | |
| \| | Ē = E; | |
| \| | for u ε V do | |
| \| | \| | if sᵤ > x or dᵤ > y or fᵤ > z then |
| \| | \| | \| affected (u); |
| \| | \| | end |
| \| | end | |
| end | | |
| affected (u) | | |
| begin | | |
| \| | A = A ∪ u; | |
| \| | for v:(u, v) ε Ē do | |
| \| | \| | k = #{w:(w, v) ε E}; |
| \| | \| | $with probability 1 - \frac{{p}_{k} - 1}{{p}_{k}} \text{:} affected ( v ) \overline{E} = \overline{E} \backslash ( u , v ) ;$ |

| | |
|---|---|
| \| | end |

end

In order to evaluate the potential of caps in a possible network scenario of application, the data from one nation-wide MVNO which currently offered packages with unlimited services (on-net calls, SMS or mobile broadband) was studied and the results are evaluated below. The relative total balance is computed as the ratio between the total balance under caps and the total balance without caps.

$$relative total balance = \frac{B ( x , y , z )}{{\sum }_{u} {b}_{u}} .$$

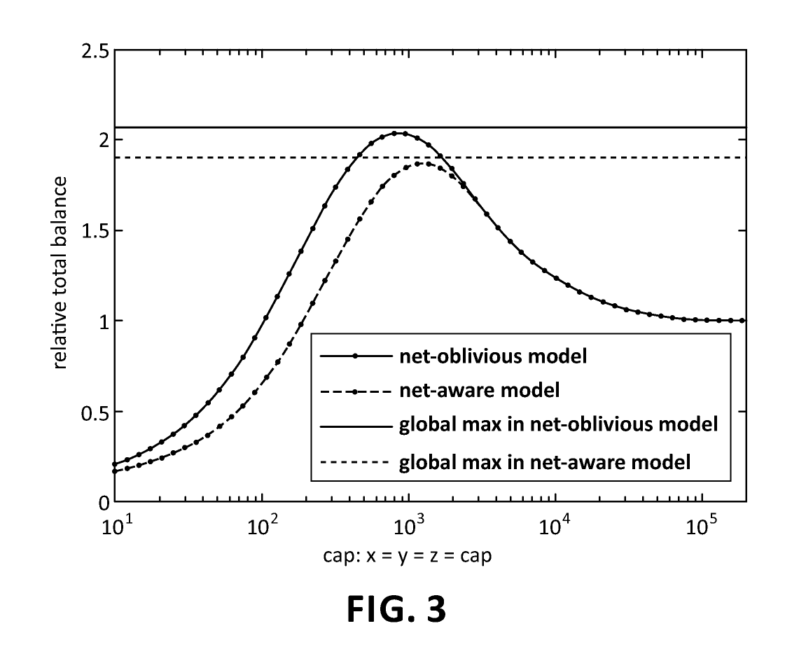

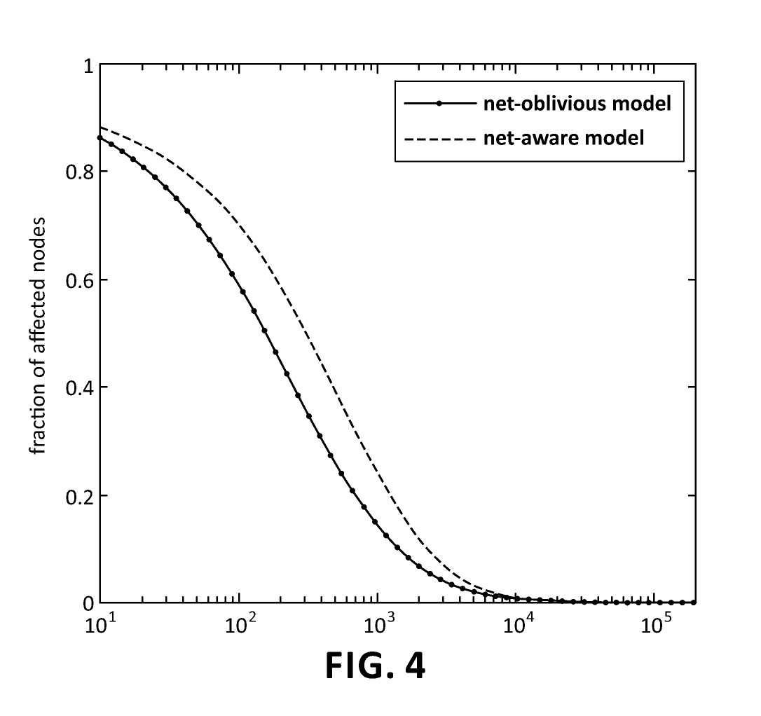

The relative total balance for both models, net-oblivious model and net-aware model, were reported while varying the cap values (same number of free SMSs, MBytes of 3G data and on-net minutes), as shown in FIG. 3. The absolute maxima of relative total balance in both models are also plot in FIG. 3, obtained by solving the optimization problems using a brute-force greedy approach. FIG. 4 shows the fraction of affected nodes, i.e., number of nodes belonging to the set A, under the caps x, y, z; x=y=z in the example. The following conclusions can be inferred from the results. First, carefully designed caps can significantly increase the total balance: a factor of (around) two increases can be expected in both models. Second, in the net-aware model a lower total balance can be expected, though the impact of cap-initiated social pruning users leaving due to network effects appears to be relatively small, and results in relatively small difference between the total balance in the two models of under 10%. Third, the cap in the simple form of x SMSs, x MB of 3G data and x free minutes of on-net calls, can recover most of the gains. Additionally, the optimal cap x that maximizes the total balance is around x₀=1150 in the net-aware model and around x′₀=800 in the net-oblivious model. Having slightly higher cap means that less nodes are directly affected by the cap and hence less nodes are affected indirectly by the social pruning. Overall around 16% of nodes are affected by the caps at the optimal point in both models. The absolute maxima of relative total balance are achieved for:

(xₒₚₜ, yₒₚₜ, zₒₚₜ)=(931 SMS, 1240 MB, 354 min) in the net-oblivious model,

(x′, y′ₒₚₜ, z′ₒₚₜ)=(1361 SMS, 1650 MB, 471 min) in the net-aware model.

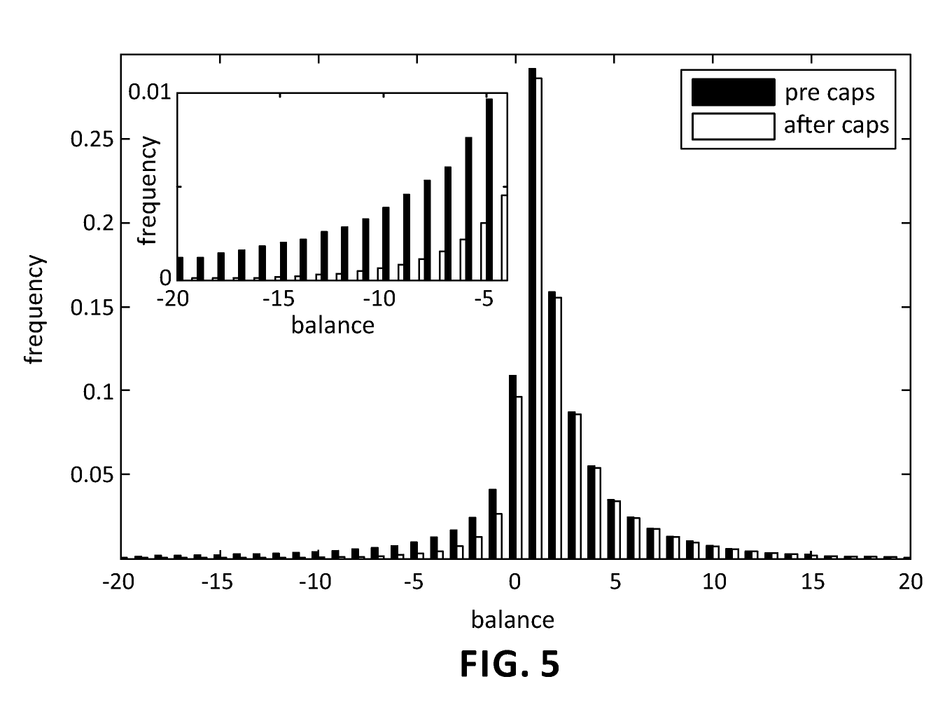

FIG. 5 depicts the distribution of the balance per customer without using caps (pre caps,) and with the optimal caps (after caps) calculated using the net-aware model. The net-aware model for computing the affected nodes which is used in the application scenario of the illustrated example applies an optimal cap defined by 1361 SMSs, 1650 Mbytes of mobile data bandwidth and 471 minutes of voice calls. The histogram shows that almost no users with balance>1 (=the mean) are affected by the cap, some customers are affected when the balance is close to zero, and almost all customers with large negative balance are detected by caps. Therefore, most users with positive balance remain non-affected, while a large fraction of those with negative balance get removed due to caps.

Note that in this text, the term “comprises” and its derivations (such as “comprising”, etc.) should not be understood in an excluding sense, that is, these terms should not be interpreted as excluding the possibility that what is described and defined may include further elements, steps, etc.

1. A method for optimizing traffic volume caps in a mobile cellular network which has a number Nₖ of customers with a number k of contacts with a user, k≧0, the method comprising:
defining three traffic volume caps (x, y, z), wherein a first volume cap x indicates number of messages from mobile messaging services, a second volume cap y indicates bandwidth for mobile data and a third volume cap z indicates duration time of voice calls;
computing an initial balance of the user by subtracting a total traffic cost generated by the user for the mobile cellular network operator from a total revenue paid by the user to the mobile cellular network operator;
obtaining a total balance of the user for a range of traffic volume caps (x, y, z) using the initial balance and at least a model of the balance which determines whether the user is affected by the traffic volume caps (x, y, z); and
selecting optimal traffic volume caps (xₒₚₜ, yₒₚₜ, zₒₚₜ) which maximize the total balance for the user.

2. The method according to claim 1, wherein the total revenue is calculated from billing records of the mobile cellular network operator for the user on a predefined time period.

3. The method according to any of claim 1, wherein the mobile cellular network operator is a Mobile Virtual Network Operator.

4. The method according to claim 3, wherein the total traffic cost is calculated by a linear function of usage by the user of network services in the mobile cellular network operator.

5. The method according to any of claim 1, wherein the mobile cellular network operator is a Mobile Non-Virtual Network Operator.

6. The method according to claim 5, wherein the total traffic cost is calculated based on demand of network services by the user in the mobile cellular network operator.

7. The method according to claim 1, wherein the model is a net-oblivious model which determines that a user u is affected by the traffic volume caps (x, y, z) if the user u is not a customer of the mobile cellular network operator and the total balance for the user u is obtained as:
$$B ( x , y , z ) = {\sum }_{u} {b}_{u}^{( x , y , z )} , where {b}_{u}^{( x , y , z )} = \{ \begin{matrix}0 & if ( {s}_{u} > x ) ⋁ ( {d}_{u} > y ) ⋁ ( {f}_{u} > z ) \\ b ( u ) & otherwise\end{matrix}$$
sᵤ denoting number of messages from mobile messaging services, dᵤ denoting broadband of mobile data and fᵤ denoting duration time of voice calls, consumed by the user u on average, and b(u) being the initial balance of the user u.

8. The method according to claim 1, wherein selecting optimal traffic volume caps ( xₒₚₜ, yₒₚₜ, zₒₚₜ) takes call graph interactions with the mobile cellular network operator for voice calls or mobile messaging services among users.

9. The method according to claim 1, further comprising computing social attraction parameters pₖ for k=0, 1, 2, . . . , wherein a social attraction parameter pₖ is a fraction of customers of the mobile cellular network operator which have k contacts in the mobile cellular network operator.

10. The method according to claim 9, wherein the model is a net-aware model which determines that a user u is affected by the traffic volume caps (x, y, z) if the user u belongs to a set A of affected nodes defined in a social graph G=(V, E) of the mobile cellular network, where edges E between nodes V represent interactions of customers of the mobile cellular network operator for voice calls or mobile messaging services, the set A of affected nodes being built by adding every user which uses a number of messages from mobile messaging services higher than the first volume cap x, a broadband of mobile data higher than the second volume cap y or a duration time of voice calls higher than the third volume cap z, and adding to the set A of affected nodes every contact v of the user u with a probability 1−pₖ₋₁/pₖ where k is the number of contacts of the contact v, and the total balance for the user u is obtained as:
$${B}^{′} ( x , y , z ) = {\sum }_{u} {b}_{u}^{′ ( x , y , z )} , where {b}_{u}^{′ ( x , y , z )} = \{ \begin{matrix}0 & if u ∈ A \\ b ( u ) & otherwise\end{matrix}$$

11. The method according to claim 9, further comprising computing a number Fₖ of national users of the mobile cellular network operator and computing the social attraction parameter pₖ as
$${p}_{k} = \frac{{N}_{k}}{{F}_{k}}$$

12. A digital data storage medium storing a computer program product comprising instructions causing a computer executing the program, to perform all steps of a method according to claim 1.
